(19) United States
(12) Patent Application Publication
(10) Pub. No.: US 2015/0206240 A1
(43) Pub. Date: Jul. 23, 2015

(54) Interactive Investing System and Method

(71) Applicant: Andrew H. Baker, Citrus Heights, CA (US)

(72) Inventor: Andrew H. Baker, Citrus Heights, CA (US)

(21) Appl. No.: 14/158,201

(22) Filed: Jan. 17, 2014

(51) Int. Cl. G06Q 40/06

(52) U.S. Cl. CPC G06Q 40/06

(57) ABSTRACT

A system and method for interactive investing allows an investor or consumer to engage an organization and manipulate a security in a simulated environment. The organization and security are depicted as graphical representations, such as avatars, a 3-D objects, and virtual currency in a simulated environment. The security can be traded on a graphical depiction of a trading platform. Engaging a graphical representation of the organization or security triggers events and benefits, such as receiving promotions, participating in games, and receiving news and alerts. These events occur in the simulated environment or the real world. The investor or consumer interacts with other users in the simulated environment to form a network of investors, consumers, game players, and researchers. The simulated environment encourages investors and consumers to communicate and engage on a common platform. The simulated environment provides an entertaining and informational system for interacting with the organization and security.

### BACKGROUND OF THE INVENTION

1. Field of the Invention

This invention relates to interactive investing, and more particularly relates to a system and method for interacting with a company and manipulating a security through graphical representations, avatars, and virtual currency for both real world and virtual benefits.

2. Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In many instances, a life simulation game often comprises a game in which the player lives or controls one or more artificial life forms. A life simulation game can revolve around individuals and relationships, or it could be a simulation of an ecosystem. A player usually interacts with other players in a network, with each player being represented by a graphical character, such as an avatar.

Often in computing, an avatar is the graphical representation of the user or the user's alter ego or character. It may take either a three-dimensional form, as in games or virtual worlds, or a two-dimensional form as an icon in Internet forums and other online communities.

It is well known that computer networks, such as the Internet, provide access to a tremendous amount of information relating to various companies and their products. It is difficult, however, for a user to investigate a particular product or service on a computer network when the product is sold under more than one name, or when the user is not sure of the proper name of the product. Similarly, the user may not know who is a manufacturer or a local supplier of the product.

Typically, a financial investment involves putting money into an asset with the expectation of capital appreciation, dividends, and/or interest earnings. This may or may not be backed by research and analysis. Most or all forms of investment involve some form of risk, such as investment in equities, property, and even fixed interest securities which are subject, among other things, to inflation risk. There are numerous trading platforms for researching and trading securities.

Typically, marketing involves advertising or otherwise promoting the sale of a product or service. In some instances, marketers attempt to identify the set of decision makers most likely to make a purchase. Another marketing technique is to give free samples of the product or service. But even after receiving samples, the merchant remain disproportionately burdened by costs.

It is known that selling is the final stage in marketing, which also includes pricing, promotion, positioning and product. A marketing department has the goals of increasing the desirability and value to the consumer and increasing the number and engagement of interactions between potential consumers and the merchant. Achieving this goal may involve the marketer using promotional techniques such as advertising, sales promotion, publicity, and public relations, or on a more technical level, interacting with the potential consumer via social media such as Twitter, Facebook, and blogs.

Often, an investor or consumer desires to research and purchase shares in a security for a company. The investor or consumer may also be interested in purchasing the product or service provided by the company. The investor or consumer may also be interested in ancillary functions that are pertinent to the company and its security. Often, a network of consumers and investors can be helpful to each other for providing information, trading partners, or playing competitive games.

In view of the foregoing, it is clear that these traditional techniques are not perfect and leave room for more optimal approaches.

### SUMMARY OF THE INVENTION

From the foregoing discussion, it should be apparent that a need exists for a system and method for interactive investing. The interactive investment system and method allows an investor or consumer to engage an organization and manipulate a security in a simulated environment. The organization or organization may be depicted as a graphical representation, such as an avatar, a 3-dimensional object, a building, a simulated object, and virtual currency. The investor or consumer may interact with at least one user in the simulated environment to form a network of investors, consumers, game players, sports fans, and researchers. The simulated environment may be efficacious for encouraging investors and consumers to communicate and engage on a common platform. The simulated environment may also provide a more entertaining and informational system for relating to the organization and the underlying security.

In one embodiment of the present invention, the system and method allows the investor or consumer to obtain a security for an organization. The security is represented as a security graphical representation, and manipulated in a graphical security trading platform. The security and the underlying fundamentals and technicals of the security are represented graphically, thereby enabling trading and research of the security in a user friendly graphical user interface. By manipulating the security graphical representation, the investor or consumer can perform various tasks in the simulated world that are pertinent to the security or the organization related to the security.

In one embodiment, engaging the security graphical representation enables the investor to make changes and perform unique functions in the simulated environment. For example, engaging or investing in a drug company allows the investor to open a pharmacy business in the simulated environment and generate virtual currency. Additionally, the investor or consumer may receive discounts on medication in the real world.

In another embodiment, engaging the security graphical representation enables the investor to assign data to the security or receive live feed data about the security. Engaging the security graphical representation also generates visual and audio communications, such as voices stating information, music, alert sounds, and informative videos.

In some embodiments, the system and method allows the investor or consumer to engage an organization. The organization is represented as an organization graphical representation, and may be engaged by the investor or consumer to receive benefits, such as, discounts, information, and interaction in a game. The benefits include both real world and virtual benefits. For example, engaging an organization graphical representation of a building for a tire company generates discounts for future tire purchases for the investor or consumer. In this manner, the investor better understands the product or service being invested in, and the consumer receives benefits and feels integrated with the organization.

In one embodiment, engaging the organization graphical representation enables the consumer to receive prices, organization news, and promotions about the organization. Engaging the organization graphical representation also generates visual and audio events, such as voices stating organization information, music, alert sounds, and promotional videos. In one embodiment, engaging the organization graphical representation allows the consumer to customize the simulated environment and perform unique functions in the simulated environment. For example, engaging a tractor trailer factory allows the consumer to till land and plant crops in the simulated environment. The subsequent crops may be sold to at least one user for virtual currency. Myriad other possibilities are possible considering the eclectic organizations represented in the security markets.

Additionally, the system and method allows an investor or consumer to interact with at least one user in the network. The at least one user may include, without limitation, a game player, an investor, a consumer, a discount shopper, and an investment researcher. The interaction with the at least one user may include sharing information, gaming competitions, social interactions, utilizing products from the organization to engage other users, and generating revenue through commercial trade with other users. These multi-user interactions events occur in the simulated environment, often with graphical representations of characters depicting each user. The simulated environment may be efficacious for encouraging investors, consumers, and users to communicate and engage on a common platform.

In an additional embodiment, the system and method may provide a key to the investor for accessing a plurality of traditional security trading platforms and a graphical security trading platforms. The key is encrypted and unique to the investor, enabling the investor to manipulate and trade the security on both traditional and graphical security trading platforms in the simulated environment. In this manner, the investor is not required to purchase the security through the simulated environment.

In one aspect of the present invention, an interactive investment system and method comprises:
investing in an organization to obtain a security;
representing the security with a security graphical representation and
representing the organization with an organization graphical representation;
manipulating the security through the security graphical representation;
interacting with the organization through the organization graphical representation; and
engaging at least one user.

In a second aspect, the system and method provides a simulated environment containing a graphical representation of an organization, a graphical security trading platform, and a traditional security trading platform. The graphical representations may be engaged by an investor or consumer for trading, playing games, receiving benefits, researching, and customizing the simulated environment.

In another aspect, the organization includes a company that generates revenue for shareholders, and provides shares of stocks in a stock market.

In yet another aspect, the organization graphical representation includes a building, person, product or service, or logo associated with an organization. Engaging the organization graphical representation provides benefits, discounts, organization information, research information, and virtual products and services for interacting with at least one user.

In another aspect, the security may include a financial instrument, a note, a stock, a bond, a certificate of interest, and a tradable asset of any kind.

In yet another aspect, the security graphical representation includes a graphical security trading platform displaying a graphical representation of the organization for which the security belongs. The security graphical depiction includes information about the security, including, without limitation, the number of users in the system who own the security and who are active in the simulated environment of the security; the price for bids and asks; periodical earnings; technical trading charts; discount offers; benefits for purchasing a product or service from the organization; and marketing material for organizations similar to the security.

In yet another aspect, manipulating the security graphical representation includes tracking the fundamentals and technical charts, obtaining the security, researching the security, and recommending the security to at least one user.

In yet another aspect, virtual currency can be used to obtain virtual and non-virtual products and services from the organization and to trade with the at least one user in the simulated environment. The virtual currency can also be used to buy shares of the security during normal trading hours, and after hours.

In yet another aspect, engaging the at least one user includes sharing information, competing in games, social interactions, utilizing products and services from the organization to engage other users, and generating revenue through commercial trade with other users in the simulated environment.

In yet another aspect, engaging the security graphical representation and the organization graphical representation results in a visual communication and an audible communication. The visual communication allows the investor or consumer to view the progress of the security, view events with the organization, view at least one user, and view games, promotions, and videos in the simulated environment. The audible communication allows the investor or consumer to hear news, alerts, and information about the security and the organization.

In yet another aspect, joining the network may be free. An organization owner or game master may utilize the system for numerous mutual benefits, including, without limitation, educating others about the organization or security, introducing concepts, enabling multiple graphical security trading platforms, enabling another outlet for selling the product or service, distributing discounts and promotions, and generating revenue. For example, owning a predetermined number of securities in an oil company qualifies the investor to obtain free gas in the simulated environment or in the real world from the oil company, while the oil company receives relatively inexpensive advertising and exposure to consumers and investors.

In yet another aspect, the key that enables the investor to manipulate and trade the security on various graphical and traditional security trading platforms is encrypted, and unique to the investor. The investor utilizes the key to gain access to the graphical and traditional security trading platforms.

One objective of the present invention is to create a more informative and entertaining environment for investing in a security and relating to the underlying organization for the security.

Another objective is to create a network of investors and consumers in a simulated environment that encourages interaction between them.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a flowchart diagram for a method of interactive investing, in accordance with an embodiment of the present invention;

FIGS. 2A and 2B illustrate different embodiments of security trading platforms, where FIG. 2A illustrates a traditional security trading platform for receiving orders, and FIG. 2B illustrates a graphical representation of a security trading platform for receiving orders, in accordance with an embodiment of the present invention;

FIG. 3 illustrates an organization graphical representation in a simulated environment associated with an underlying investment, in accordance with an embodiment of the present invention; and

FIG. 4 illustrates a block diagram depicting an exemplary client/server system which may be used by an exemplary web-enabled/networked, in accordance with an embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

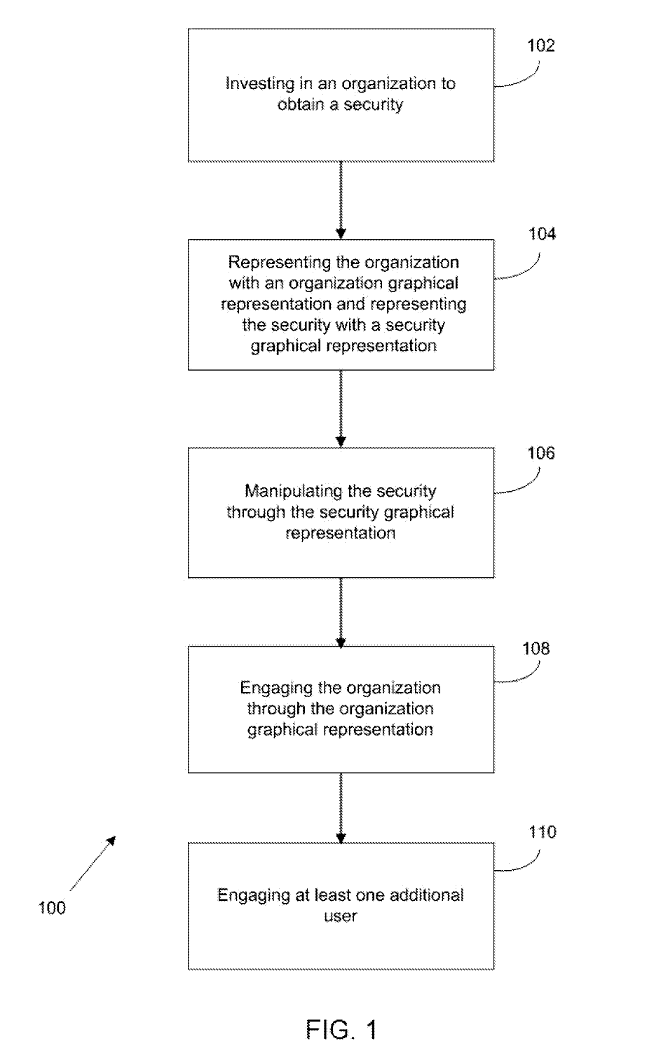

FIG. 1 discloses a method 100 of interactive investing that provides a graphical simulated environment 214 and network of at least one user for interactive trading of a security 206 and engagement with an organization 208 that is associated with the security 206. In some embodiments, the method 100 may enable a consumer 222 to engage the organization 208 and trigger events in the simulated environment 214. The method 100 may also allow an investor 224 to manipulate the security 206 to perform investment related trading and research activities. The organization 208 and the security 206 may be depicted as a graphical representation, such as an avatar, a 3-dimensional object, an image, a simulated object, a virtual city, a virtual business, and virtual currency.

In some embodiments, the investor 224 or consumer 222 may interact with at least one user in the simulated environment 214 to form a network of investors 224, consumers 222, game players, and researchers. The simulated environment 214 may be efficacious for encouraging investors 224 or consumers 222 to communicate and engage on a common platform. The simulated environment 214 may also provide a more entertaining and informational system for relating to the organization 208 and the underlying security 206.

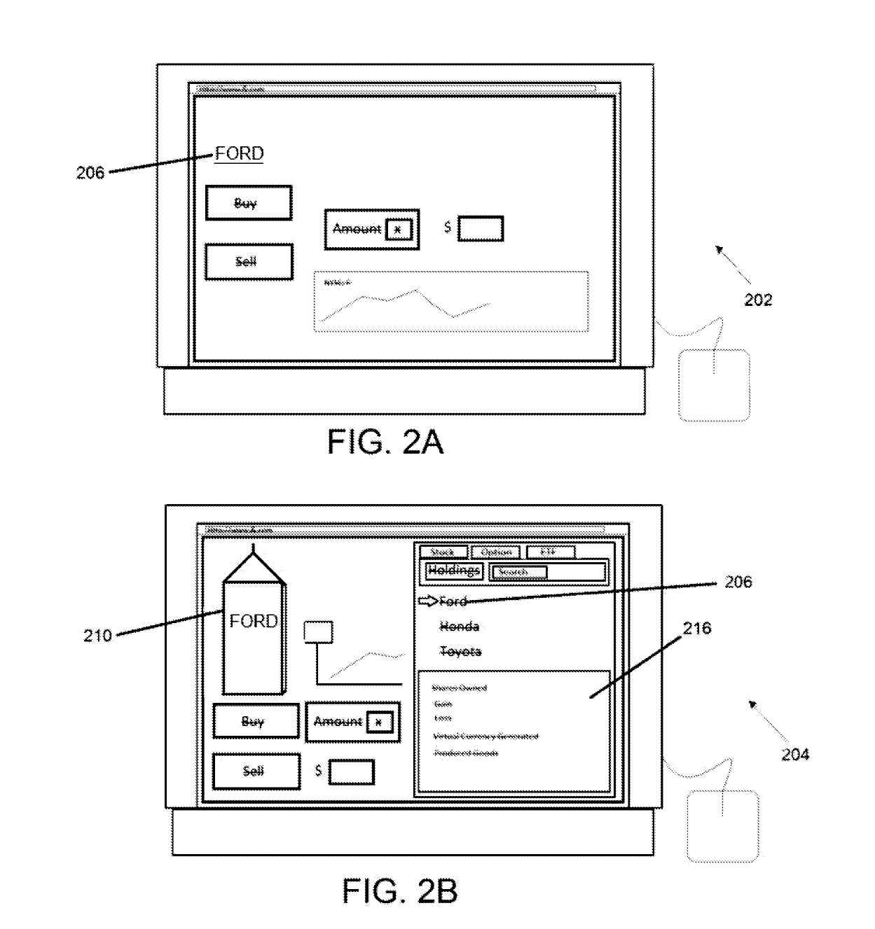

This novel interactive investing method 100 provides a first Step 102 of investing in an organization 208 to obtain a security 206. The investor 224 may purchase the security 206 with real currency. However in other embodiments, the investor 224 obtains a virtual security in the simulated environment 214 with virtual currency. In this manner, the investor 224 can better learn about and research the security 206 and the organization 208 prior to investing with real money. The investor 224 or consumer 222 can research and trade the security 206 on a graphical security trading platform 204, as that referenced in FIG. 2B. The graphical security trading platform 204 offers a more robust, intuitive display than the traditional security trading platform 202. The virtual currency can be used to obtain virtual and non-virtual products and services from the organization and to trade with the at least one user in the simulated environment. The virtual currency can also be used to buy shares of the security 206 during normal trading hours, and after hours.

For example, without limitation, the organization 208 may include an automobile company, as referenced in FIG. 2B. A graphical representation of an automobile may appear during a purchase of the security 206. In one embodiment, the graphical representation of the automobile may include the most recent model, whereby the organization 208 is effective in not only selling the security 206, but also educating the investor 224 about the products and services offered.

The graphical security trading platform 204 displays an image representative of the organization 208 for which the security 206 belongs. The graphical security trading platform 204 also includes information about: quantity of investors 224 who own the security 206 and who are active in the simulated environment 214, bid and ask quotes for the security 206, volumes for the security 214, earnings, technical information about the security 206, discount offers from the organization 208, benefits for purchasing a product or service from the organization 208, and marketing material for at least one additional organization. Suitable security trading platforms 202, 204 may include, without limitation, NYSE™, NASDAQ™, E-Trade™, Ameritrade™, and Charles Schwabb™

In some embodiments, a broker, either real or virtual, may provide an encrypted key to the investor 224 that enables access to various other types of security trading platforms, such as a traditional security trading platform 202, such as that referenced in FIG. 2A. The key is encrypted and unique to the investor 224, enabling the investor 224 to manipulate and trade the security 206 on different security trading platform. In this manner, the investor 224 is not required to purchase the security 206 through the simulated environment 214. The key comprises an encrypted code unique to the investor 224 as an identity theft and fraud prevention feature.

The security 206 may include any note, stock, treasury stock, bond, debenture, certificate of interest or participation in any profit-sharing agreement or in any oil, gas, or other mineral royalty or lease, any collateral trust certificate, preorganization certificate or subscription, transferable share, investment contract, voting-trust certificate, certificate of deposit, for a security, any put, call, straddle, option, or group or index of securities, or any put, call, straddle, option, or privilege entered into on a national securities exchange relating to foreign currency, or in general, any instrument commonly known as a “security”; or any certificate of interest or participation in, temporary or interim certificate for, receipt for, or warrant or right to subscribe to or purchase, any of the foregoing; but shall not include currency or any note, draft, bill of exchange, or banker's acceptance which has a maturity at the time of issuance of not exceeding nine months, exclusive of days of grace, or any renewal thereof the maturity of which is likewise limited.

A next Step 104 may include representing the organization 208 with an organization graphical representation 212, and representing the security 206 with a security graphical representation 210. The system may utilize a graphical user interface (GUI) to frame the organization 208 and the security 206 in the simulated environment 214. The simulated environment 214 may have the look and feel of a traditional strategic life simulation game, such as The Sims™ game.

The security graphical representation 210 may provide an entertaining and decorative depiction of the organization 208 and the associated security 206. In some embodiments, the security graphical representation 210 includes a trading interface to transfer one or more shares of the security 206 from a first user of the system to a second user of the system, and to transfer a price of the one or more shares of the security 206 from an account of the first user to an account of the second user.

In some embodiments, the organization graphical representation 212 may include an image of an object that is associated with the organization 208. For example, a security 206 for a telephone service organization is represented by a 3-dimensional graphic of a telephone pole in the simulated environment 214. The user may receive a benefit 216 and trigger events by engaging the telephone pole by clicking on it. The benefit 216 may include free phone calls in the simulated environment 214 or a phone service discount or free phone book in the real world.

The organization graphical representation 212 may include an image of a building, person, product or service, or logo associated with the organization 208. In one embodiment, the organization graphical representation 212 may include, without limitation, an image of a restaurant, a building, a stadium, a gas station, and a vehicle in the simulated environment 214. The organization graphical representation 212 may be associated with the security 206, and indicative of the properties of the security 206.

For example, an automobile represents a security 206 for a specific automobile brand. The size of the automobile is proportional to the amount of securities owned by the investor 224. A large automobile may represent 10,000 shares of the security 206, while a small automobile may represent 1,000 shares of the security 206. Additionally, the consumer 222 or investor 224 and the at least one user each posses and customize graphical representations of organizations and securities placed throughout the simulated environment 214. This eclectic display creates the system for the present invention.

The method 100 may utilize an additional Step 106 of manipulating the security 206 through the security graphical representation 210. Often, this is done by clicking on a graphical user interface showing the security graphical representation 210 and a graphic security trading platform 204. In some embodiments, manipulating the graphic security trading platform 204 includes tracking the fundamentals and technical charts, obtaining the security 206, researching the security 206, reading reviews about the security 206, and recommending the security 206 to at least one user.

Additionally, manipulating the graphic security trading platform 204 in the simulated environment 214 enables the investor 224 or consumer 222 to perform tasks in the simulated environment 214. For example, clicking on an image of the security graphical representation 210 or organization graphical representation 212 allows the investor 224 to perform technical, industrial, and scientific activities; produce products; provide services; trade, buy, and sell products; and generate monetary value. When engaged by the investor 224, the security graphical representation 210 generates visual and audio effects that provide news, ticker tape quotes, prices, trade volume, organization news, stock market news, alerts, and images pertinent to the security 206 and the organization 208 that the security 206 represents. The graphic security trading platform 204 may be manipulated to buy shares of the security 206 during normal trading hours, and after hours.

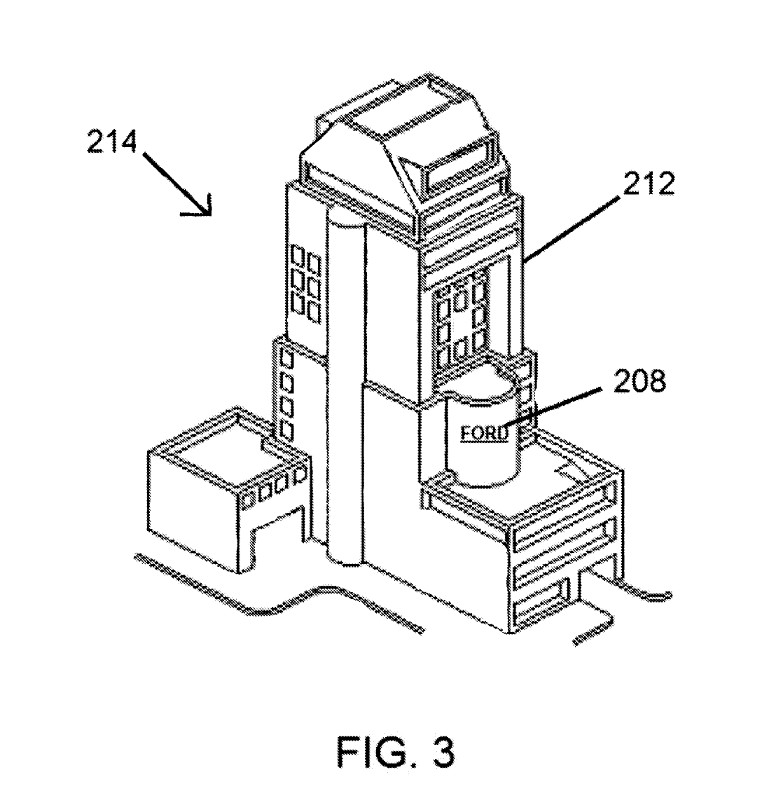

FIG. 3 depicts a Step 108 of interacting with the organization 208 through the organization graphical representation 212. In one embodiment, the organization 208 may be engaged and interacted by clicking on an organization graphical representation 212. The engagement may trigger an event, such as receiving news about the organization 208, purchasing a product or service from the organization 208. Engaging the organization graphical representation 212 also enables the consumer 222 or investor 224 to receive a benefit 216. The benefit 216 may include, without limitation, receiving promotional offers and discounts from the organization 208, registering in a contest, and playing a game associated with the organization 208. FIG. 3 illustrates a building that represent an organization 208 being engaged by a consumer 222, and generating a visual affect, such as a change of color. Engaging the organization graphical representation 212 provides the benefit 216, which includes discounts, organization 208 information, research information, and virtual products and services for interacting with at least one user. The organization graphical representation 212 may include buildings that are part of a larger simulated environment 214, such as that found in a traditional strategic life simulation game.

FIG. 3 is part of a simulated environment 214 containing a plurality of organization graphical representations 212. The simulated environment 214 adheres to the interests, as well as the social and basic needs, of a community. The simulated environment's 214 main goal is to serve as a common ground for people who share the same interests as one another, such as shopping or investing in an organization 208. In this embodiment, the simulated environment 214 comprises an eclectic virtual community that displays online. The virtual community is enabled through members by taking part in membership rituals. The consumer 222 or investor 224 may move freely through any section of the virtual community, visiting organization graphical representations 212 for investigating, purchasing, or investment research. The consumer 222 or investor 224 and other users in the virtual community may be graphically represented, often with an image of an avatar or character. Any virtual currency, tools, contacts, schedules, and benefits 216 may also display at the periphery of the virtual community for instant access during interactions. The interactions involve interacting with the organization 208, the security 206, and other consumers 222 and investors 224. However in game type situations, additional interactions may be possible.

For example, without limitation, clicking on a football stadium in the virtual community allows the consumer 222 or investor 224 to participate in a fantasy football league. Clicking on a rival team's football stadium allows the consumer 222 or investor 224 to play a football game against that team. Interacting with the football stadium may also provide scores for a real world game, opportunities to purchase tickets, and statistics for the players. Additionally, the consumer 222 or investor 224 can customize the team associated with the stadium by selecting a team, players, a team color, and other parameters of the football game. In this manner, a bond may form between the team and the consumer 222, investor 224, and football fan.

Other examples of interacting with the organization 208 to trigger an event in the real world may include, without limitation, interacting with a restaurant graphical representation to receive coupons; interacting with a motorcycle shop to customize a motorcycle, preorder a motorcycle, and buy motorcycle gear; interacting with a representational produce item to trade, sell, or buy from at least one user.

In yet more examples, the consumer 222 engages a graphical representation of a road construction organization. The consumer 222 then has the capacity to build a road in the simulated environment 214. The consumer 222 engages a graphical representation of a football stadium to play a football game with at least one user from a computer. The promotions, services, and products obtained from the interaction can be realized in the simulated environment 214 or the real world.

In some embodiments, engaging the security graphical representation 210 and the organization graphical representation 212 results in a visual communication and an audible communication. The visual communication allows the investor 224 or consumer 222 to view the progress of the security 206, view events with the organization 208, view at least one user, and view games, promotions, and videos in the simulated environment 214. The audible communication allows the investor 224 or consumer 222 to hear news, alerts, and information about the security 206 and the organization 208.

A final Step 110 includes engaging at least one user. The system and method allows an investor 224 or consumer 222 to interact with at least one user in the network. The at least one user may include, without limitation, a game player, an investor 224, a discount shopper, and an investment researcher. The interaction with the at least one user may include sharing information, game type competitions, social interactions, utilizing products from the organization 208 to engage other users, and generating revenue through commercial trade with other users in the simulated environment 214. These multi-user interactions events occur in the simulated environment 214, often with graphical representations of characters depicting each user.

In some embodiments, the investor 224 or consumer 222 may trigger events, receive a benefit 216, and customize the simulated environment 214 by interacting with the organization 208 and security graphical representation 210. The investor 224 or consumer 222 does not have to own the security 206 or a product from the organization 208 in order to participate in the simulated environment 214 and engage the security 206 or organization 208 in the simulated environment 214. In this manner, any party may introduce items and events into the simulated environment 214 with minimal exposure. However, the investor 224 or consumer 222 learns about the organization 208 by participating in this manner. This may result in a new consumer 222 or investor 224.

In one embodiment of the present invention, joining the network does not cost money for the investor 224 or consumer 222. An organization owner or game master may utilize the system for numerous mutual benefits 216, including, without limitation, educating others about the organization 208 or security 206, introducing concepts, enabling additional platforms for trading the security 206, enabling another outlet for selling the product or service, distributing discounts and promotions, and generating revenue. For example, owning a predetermined number of securities in an oil company qualifies the investor 224 or consumer 222 to obtain free gas in the simulated environment 214 or in the real world from the oil company.

In one alternative embodiment, the simulated environment 214 is linked to real time geopolitical events. For example, if an investor 224 desires to invest in a silver mining organization, the simulated environment 214 can depict Indonesia, where silver mining occurs. The investor 224 can engage graphical representations in an Indonesia simulated environment to study the recent events and political situation in Indonesia prior to obtaining the security 206 for the mining organization. In yet another alternative embodiment, the consumer 222 or investor 224 may purchase virtual currency for use in the simulated environment 214 with real currency. In yet another alternative embodiment, the organization 208 can include a city or state, and the security 206 can include an interest bearing bond.

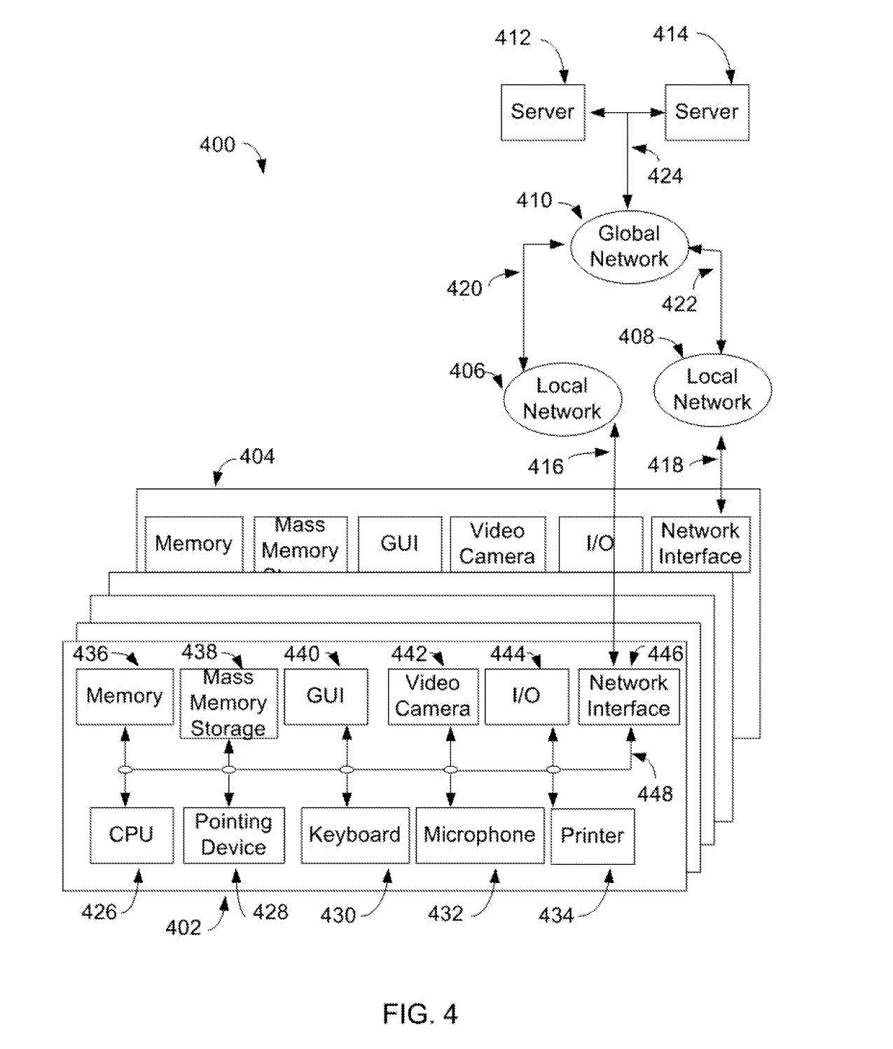

FIG. 4 is a block diagram depicting an exemplary client/server system which may be used by an exemplary web-enabled/networked embodiment of the present invention. In the present invention, a communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 446, mass memory storage 448, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. One or more computer storage media storing computer-usable instructions, that when used by one or more computing devices, cause the one or more computing devices to perform a method of interactive investing comprising the steps of:
(a) investing in an organization to obtain a security;
(b) representing the organization with an organization graphical representation, and representing the security with a security graphical representation;
(c) manipulating the security through the security graphical representation;
(d) interacting with the organization through the organization graphical representation; and
(e) engaging at least one user.

2. The method of claim 1, in which the method further comprises a step (f) of obtaining a key for accessing a plurality of security trading platforms.

3. The method of claim 2, in which the key is encrypted for inhibiting identity theft and fraud.

4. The method of claim 3, in which step (a) further comprises investing in the organization through the security graphical representation.

5. The method of claim 4, in which the organization comprises a company and the security comprises shares in stocks for the company.

6. The method of claim 5, in which the organization graphical representation comprises at least one of the following: a building, a vehicle, vegetation, a street, an avatar, an animal, and a 3-dimensional image.

7. The method of claim 6, in which the security graphical representation comprises at least one of the following information: quantity of investors who own the security and who are active in the simulated environment, bid and ask quotes for the security, volumes for the security earnings, technical information about the security, discount offers from the organization, benefits for purchasing a product or service from the organization, or marketing material for at least one additional organization.

8. The method of claim 7, in which step (c) further comprises manipulating the security through researching, buying, and selling the security on a graphical security trading platform.

9. The method of claim 8, in which step (d) further comprises interacting with the organization through the organization graphical representation by clicking on a graphical depiction of a building.

10. The method of claim 9, in which clicking on a graphical depiction of a building provides information about the organization and the security associated with the organization.

11. The method of claim 10, in which engaging the organization graphical representation and/or the security graphical representation triggers a visual communication, the visual communication comprising a news feed, a color change, and a movement on the simulated environment.

12. The method of claim 11, in which engaging the organization graphical representation and/or the security graphical representation triggers an audible communication, the audible communication comprising an alert, a news feed, music, and a human voice.

13. The method of claim 12, in which the at least one user comprises an investor, and/or a consumer, and/or a bargain hunter, and/or a sports fan, and/or a gamer, and/or a researcher.

14. The method of claim 13, in which the benefit comprises a discount, and/or a free product, and/or a free service, and/or information, and/or bonus points.

15. The method of claim 14, in which step (e) further comprises engaging the at least one user by playing a competitive game in the simulated environment.

16. The method of claim 15, in which the system is free to use for the investor, and the consumer, and the at least one user.

17. The method of claim 16, in which the investor, and the consumer, and the at least one user are represented by an avatar character.

18. The method of claim 17, in which the investor, and the consumer, and the at least one user use a virtual currency to purchase a virtual security and a virtual product or service in the simulated environment.

19. A system for interactive investing, the system comprising:
means for investing in an organization to obtain a security;
means for representing the organization with an organization graphical representation, and representing the security with a security graphical representation;
means for manipulating the security through the security graphical representation means for interacting with the organization through the organization graphical representation; and
means for engaging at least one user.

20. A non-transitory program storage device readable by a machine tangibly embodying a program of instructions executable by the machine to perform a method for Donating, the storage device comprising:
(a) computer code for investing in an organization to obtain a security;
(b) computer code for representing the organization with an organization graphical representation, and representing the security with a security graphical representation;
(c) computer code for manipulating the security through the security graphical representation;
(d) computer code for interacting with the organization through the organization graphical representation; and
(e) computer code for engaging at least one user.
